(19) United States
(12) Patent Application Publication
(10) Pub. No.: US 2010/0047598 A1
(43) Pub. Date: Feb. 25, 2010

(54) Coating compositions and methods of blocking tannin migration

(75) Inventors: Carl J. Sullivan, Chapel Hill, NC (US); Alan Douglas Roberts, Raleigh, NC (US); Stephen R. Shearon, Raleigh, NC (US); Ryan P. Thomas, Graham, NC (US); Jeffrey Danneman, Raleigh, NC (US)

Correspondence Address: MYERS BIGEL SIBLEY & SAJOVEC, PO BOX 37428, RALEIGH, NC, 27627, US

(73) Assignee: REICHHOLD, INC.

(21) Appl. No.: 12/545,909

(22) Filed: Aug. 24, 2009

Related U.S. Application Data
(60) Provisional application No. 61/091,550, filed on Aug. 25, 2008.

(51) Int. Cl. B32B 27/10; C09D 139/06; B32B 27/06

(52) U.S. Cl. 428/511; 524/516; 525/203; 428/500

(57) ABSTRACT

This present invention provides coating compositions that may at least partially block tannin migration and methods of blocking tannin migration. Specifically, the coating composition comprises at least one resin binder, and at least one vinyl pyrrolidone based polymer or copolymer, or a combination thereof. The coating compositions described herein at least partially block tannin migration.

### RELATED APPLICATIONS

This application claims the benefit under 35 U.S.C. §119(e) of U.S. Provisional Patent Application Ser. No. 61/091,550; Filed Aug. 25, 2008, the disclosures of which is incorporated herein by reference in its entirety.

### FIELD OF THE INVENTION

This present invention generally relates to coating compositions and methods of blocking stain. Specifically, the present invention describes coating compositions that may at least partially block tannin migration and methods of blocking tannin migration.

### BACKGROUND OF THE INVENTION

In architectural coatings, a primer is usually applied to a substrate to provide a foundation for a durable topcoat. When the primer is applied to a stained substrate, the primer should also have effective stain blocking properties. Common examples of stains include inks, crayons, pen markers, and stains caused by water or smoke damage. Another type of stain is tannin which is abundantly present in cedar, redwood and other dark woods. Tannins are complex acidic compounds that are observed as yellow to brown. They are soluble in water and may bleed from unpainted wood and cause discoloration when a waterborne coating, such as paint, primer or varnish, is applied to the wood. In addition, tannins may inhibit curing of waterborne alkyds. Therefore, it is particularly important to block the migration of tannins when using waterborne alkyd based coatings.

Traditionally, solvent borne stain blocking coatings have been used to block a broad range of stains since most of the stains and the tannins are insoluble in the solvent carriers of the coating systems. However, due to the environmental concerns, restrictions have been imposed on volatile organic compounds (VOC) in such coating systems. In response to the regulations, it is desired to replace solvent borne coating systems with waterborne coating systems. However, since tannin is water soluble, waterborne coating systems are often ineffective at blocking tannin migration.

An exemplary waterborne stain blocking coating system is proposed in U.S. Pat. No. 6,485,786 and provides an emulsion copolymer comprising ethylenically unsaturated acid monomer. Aluminum based compounds have been incorporated in a waterborne paint composition to block tannin migration. (U.S. Pat. No. 6,533,856) Acrylic or styrene acrylic latex has been disclosed as a useful component in tannin blocking compositions. (U.S. Pat. No. 6,531,223) Titanate compounds in conjunction with latex binders are disclosed to block tannin migration. (U.S. Pat. No. 6,245,141) Zirconium based salts in a paint or pretreatment composition for high tannin woods has been discussed as inhibiting tannin staining. (U.S. Pat. No. 5,759,705) Zinc cyanamide has been disclosed to block tannin staining in latex paints. (U.S. Pat. No. 5,529,811) Some novel acrylic copolymer latex compositions with acid-functional polymer and organosilane functional latex copolymer have also been used to inhibit tannin migration. (U.S. Pat. No. 5,527,619)

Despite the development of these tannin blocking coating systems; there is a continuing need for an effective and improved coating system for blocking tannin migration.

### SUMMARY OF THE INVENTION

The present invention provides coating compositions that at least partially block tannin migration. The coating composition comprises at least one resin binder and at least one vinyl pyrrolidone based polymer or copolymer, or a combination thereof. In some embodiments, the resin binder is waterborne. In some embodiments, the resin binder is selected from acrylic latex, vinyl acetate/acrylic latex, vinyl acetate/ethylene latex, styrene/acrylic latex, styrene/butadiene latex, natural rubber latex, alkyd latex, alkyd/acrylic hybrid resins and water reducible alkyds.

In one embodiment, the molecular weight of the vinyl pyrrolidone based polymer or copolymer is in the range of about 1000 to about 1,000,000 Daltons. In some embodiments, the ethylenically unsaturated compound is selected from ethylene, propylene, acrylates, methacrylates, vinyl acetate, styrene, vinyl toluene and ethylene chloride. In another embodiment, the weight ratio of the resin binder to vinyl pyrrolidone based polymer or copolymer is in the range of about 25/75 to about 99/1 mass units.

The present invention also provides methods of blocking tannin migration which comprises the step of: applying the coating composition to a stained substrate. The coating composition comprises at least one resin binder and at least one vinyl pyrrolidone based polymer or copolymer or a combination thereof. In some embodiments, the stained substrate is a tannin-stained substrate or a tannin-containing substrate.

Another aspect of the present invention provides coated substrates comprising: a tannin-stained substrate or tannin-containing substrate (e.g. high tannin content wood), and a coating on said substrate comprising at least one resin binder and at least one vinyl pyrrolidone based polymer or copolymer or a combination thereof, wherein said coating may at least partially block the migration of tannin from the substrate. In some embodiments, the stained substrate is a tannin-stained substrate or a tannin-containing substrate (e.g. high tannin content wood).

One aspect of the present invention provides, in waterborne coating composition, wherein the improvement comprises an effective amount of at least one vinyl pyrrolidone based polymer or copolymer or a combination thereof to at least partially block tannin migration.

### DETAILED DESCRIPTION

The foregoing and other aspects of the present invention will now be described in more detail with respect to the description and methodologies provided herein. It should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise. Also, as used herein, “and/or” refers to and encompasses any and all possible combinations of one or more of the associated listed items. Furthermore, the term “about,” as used herein when referring to a measurable value such as an amount of a compound, dose, time, temperature, and the like, is meant to encompass variations of 20%, 10%, 5%, 1%, 0.5%, or even 0.1% of the specified amount. Unless otherwise defined, all terms, including technical and scientific terms used in the description, have the same meaning as commonly understood by one of ordinary skill in the art to which this invention belongs.

All patents, patent applications and publications referred to herein are incorporated by reference in their entirety. In case of a conflict in terminology, the present specification is controlling.

As used herein, the term “waterborne” means that the solvent or carrier fluid for the coating composition primarily comprises water. For example, in certain embodiments, the carrier fluid is at least about 30 weight percent water.

“Coatings” herein include compositions applied to various substrates. Exemplary coatings include, but are not limited to, those commonly identified as architectural coatings, for example, primers, paints, varnish, flat coatings, semi gloss coatings, gloss coatings, clear coatings, topcoats, stain blocking coatings, penetrating sealers for porous substrates chalky surfaces, concrete, and marble, elastomeric coatings, mastics, caulks, and sealants; industrial coatings, for example, board and paneling coatings, transportation coatings, furniture coatings, and coil coatings; maintenance coatings, for example, bridge and tank coatings and road marking paints; leather coatings and treatments; paper coatings; woven and nonwoven fabric coatings and pigment printing pastes; adhesive coatings, for example, pressure sensitive adhesives and wet- and dry-laminating adhesives; automotive coatings; and ink coatings selectively applied to produce printed images, for example letters and pictures, through techniques such as, for example ink-jetting.

The present invention provides coating compositions comprising at least one resin binder, and at least one vinyl pyrrolidone based polymer or copolymer, or a combination thereof. The coating compositions described herein at least partially block tannin migration.

Another aspect of the present invention also provides a coating composition, wherein the improvement comprises an effective amount of at least one vinyl pyrrolidone based polymer or copolymer or a combination thereof to at least partially block tannin migration.

In some embodiments, the resin binder may be waterborne. In other embodiments, the resin binder may be selected from acrylic latex, vinyl acetate/acrylic latex, vinyl acetate/ethylene latex, styrene/acrylic latex, styrene/butadiene latex, natural rubber latex, alkyd latex, alkyd/acrylic hybrid resins and water reducible alkyds. In one embodiment, the resin binder may be alkyd latex. In another embodiment, the resin binder may be acrylic latex, styrene/acrylic latex or a combination thereof.

In some embodiments, the molecular weight of the vinyl pyrrolidone based polymer or copolymer may be in the range of about 1000 to about 1,000,000 Daltons. In some embodiments, the average molecular weight of the vinyl pyrrolidone based polymer or copolymer may be in the range of about 20,000 Daltons to about 150,000 Daltons.

In another embodiment, if the vinyl pyrrolidone monomer is copolymerized, the other monomer may be an ethylenically unsaturated compound. The ethylenically unsaturated compound may be selected from ethylene, propylene, acrylates, methacrylates, vinyl acetate, styrene, vinyl toluene and ethylene chloride. In one embodiment, the ethylenically unsaturated compound may be vinyl acetate.

The monomer composition of “vinyl pyrrolidone based polymer” is about 100% vinyl pyrrolidone. The monomer composition of “copolymers of vinyl pyrrolidone” has about 1% to about 99% vinyl pyrrolidone monomer content and about 99% to about 1% of the other monomer of the copolymer. In some embodiments, the copolymer compositions contain about 40% to about 99% vinyl pyrrolidone monomer.

The vinyl pyrrolidone based polymers or copolymers of the present invention may be prepared by any process known in the art, for example the process described in U.S. Pat. No. 4,786,699. An exemplary vinyl pyrrolidone based polymer is about 55,000 Dalton homopolymer available from available from Sigma-Aldrich Corporation, catalogue #856568 (2006 catalogue)

In some embodiments, the weight ratio of the resin binder to vinyl pyrrolidone based polymer or copolymer is in the range of about 25/75 to about 99/1 mass units. In some embodiments, the ratios are about 70/30 to about 95/5 of resin binder to vinyl pyrrolidone polymer or copolymer. In one embodiment, the weight ratio of resin binder to vinyl pyrrolidone based polymer or copolymer is in the range of about 80/20 to about 95/5. In some embodiments, the weight ratio of resin binder to vinyl pyrrolidone based polymer or copolymer is in the range of about 90/10.

In other embodiments, the coating composition may optionally comprise additives such as pigment, extenders, rheology modifiers, cosolvents, coalescents, wetting agents, flow/leveling agents, viscosity controlling agents, pH controlling agents, slip resistant agents, mar resistant agents, UV stabilizers, catalysts, drier metals biocides and/or any other adjuvants that are commonly used in waterborne coatings, the selection of which will be within the skill and knowledge of one skilled in the art.

The present invention also provides a method of at least partially blocking stain migration comprising the step of applying a coating composition to a tannin-stained or tannin-containing substrate, wherein the coating compositions comprise at least one resin binder and at least one vinyl pyrrolidone based polymer or copolymer or a combination thereof. In one embodiment, the substrate is stained with tannin. In other embodiments, the coating composition is applied as a primer.

Another aspect of the present invention provides a coated substrate comprising: a tanning-containing substrate or tannin-stained substrate; and a coating on said substrate containing at least one resin binder and at least one vinyl pyrrolidone based polymer or copolymer or a combination thereof, wherein said coating can at least partially block the migration of the tannin from the substrate. In one embodiment, the substrate is a tanning-containing substrate. In other embodiments, the tannin-stained substrate is selected from wood, paper, cardboard, plywood, particle board, chip board and strand board. Yet, in another embodiment, the substrate is selected from redwood, cedar, white pine, dark wood, yellow pine and oak.

The following non-limiting examples are provided to further illustrate the coating compositions prepared according to the present invention and used for at least partially blocking tannin migration.

### EXAMPLES

### I. Examples of Coatings

Coatings for examples 1-7 were made by using manufacturing methodologies and appropriate raw materials in ratios known to those skilled in the art. These exemplary coatings employ the same pigmentation and pigment volume concentration and are otherwise similar, varying only in the choice of defoamers and coalescing solvents as demanded by the specific polymer.

Examples 1-3 use an alkyd emulsion as resin binder. Example 2 adds a vinyl pyrrolidone copolymer, Luvitec VA 64 of 35,000 Daltons and supplied by BASF, at 9.9 weight percent of the binder. Example 3 adds vinyl pyrrolidone polymer, Luvitec K 30 of 35,000 Daltons and supplied by BASF, at 9.9 weight percent of the binder. Examples 4 and 5 use styrene acrylic emulsion as resin binder, with example 5 adding vinyl pyrrolidone copolymer at 9.9 weight percent of the binder. Examples 6 and 7 use a pure acrylic emulsion as the resin binder, with example 7 adding vinyl pyrrolidone copolymer at 9.9 weight percent of the binder.

### II. Coating Compositions for Examples 1-7 are Listed in the Following Table

| | | Example | | | | | | | | |
|---|---|---|---|---|---|---|---|---|---|---|
| | | 1 | 2 | 3 | 4 | 5 | 6 | 7 | | |
| Raw Material | | Pounds* | Pounds | Pounds | Pounds | Pounds | Pounds | Pounds | Supplier | Purpose |
| Water | 1 | 133.65 | 133.53 | 133.53 | 111.44 | 111.38 | 134.85 | 133.08 | | |
| Natrasol 330 Plus | 2 | 1.21 | 1.21 | 1.21 | 1.01 | 1.01 | 1.22 | 1.20 | Aqualon | Thickener |
| 28% Ammonia | 3 | 0.19 | 0.19 | 0.19 | 0.16 | 0.16 | 0.19 | 0.19 | | pH Buffer |
| Tamol 681 | 4 | 7.34 | 7.34 | 7.34 | 6.12 | 6.12 | 7.41 | 7.31 | Rohm & | Dispersant |
| | | | | | | | | | Haas | |
| Byk 022 | 5 | 2.01 | 2.01 | 2.01 | 1.68 | 1.68 | 2.03 | 2.00 | Byk | Defoamer |
| Triton CF 10 | 6 | 2.45 | 2.45 | 2.45 | 2.04 | 2.04 | 2.47 | 2.42 | Rohm & | Dispersant |
| | | | | | | | | | Haas | |
| TiPure R-706 | 7 | 199.67 | 200.01 | 200.01 | 166.49 | 166.82 | 201.46 | 197.73 | DuPont | White Pigment |
| Duramite | 8 | 289.52 | 290.01 | 290.01 | 241.42 | 241.89 | 292.11 | 286.71 | Imerys | Extender |
| | | | | | | | | | | Pigment |
| Beckosol AQ 205 | 9 | 453.79 | 413.65 | 413.66 | 0.00 | 0.00 | 0.00 | 0.00 | Reichhold, | Polymer |
| | | | | | | | | | Inc | |
| Arolon 847 | 10 | 0.00 | 0.00 | 0.00 | 495.52 | 451.80 | 0.00 | 0.00 | Reichhold, | Polymer |
| | | | | | | | | | Inc | |
| Synthemul 40-412 | 11 | 0.00 | 0.00 | 0.00 | 0.00 | 0.00 | 503.65 | 449.48 | Reichhold, | Polymer |
| | | | | | | | | | Inc | |
| Co 5% Hydrocure | 12 | 2.50 | 2.28 | 2.28 | 0.00 | 0.00 | 0.00 | 0.00 | OMG | Drier Catalyst |
| II | | | | | | | | | | |
| Dri-Rx HF | 13 | 0.62 | 0.57 | 0.57 | 0.00 | 0.00 | 0.00 | 0.00 | OMG | Synergist |
| Zr 12% Hydro | 14 | 5.20 | 4.74 | 4.74 | 0.00 | 0.00 | 0.00 | 0.00 | OMG | Drier catalyst |
| Cem | | | | | | | | | | |
| Propylene Glycol | 15 | 11.80 | 12.54 | 12.54 | 0.00 | 0.00 | 2.54 | 4.11 | | Open Time |
| Solvent DPM | 16 | 0.00 | 0.00 | 0.00 | 16.65 | 15.18 | 0.00 | 0.00 | Lyondell | Coalescent |
| Propasol P | 17 | 0.00 | 0.00 | 0.00 | 7.28 | 6.64 | 0.00 | 0.00 | Eastman | Coalescent |
| Texanol | 18 | 0.00 | 0.00 | 0.00 | 0.00 | 0.00 | 17.63 | 15.73 | Eastman | Coalescent |
| Foamstar A34 | 19 | 2.01 | 2.01 | 2.01 | 0.00 | 0.00 | 0.00 | 0.00 | Cognis | Defoamer |
| Water | 20 | 25.14 | 25.12 | 25.12 | 20.97 | 20.96 | 15.22 | 0.00 | | |
| Rhodaline 643 | 21 | 0.00 | 0.00 | 0.00 | 0.00 | 0.00 | 2.03 | 2.00 | Rhodia | Defoamer |
| Luvitec VA 64, | 22 | 0.00 | 75.00 | 0.00 | 0.00 | 62.56 | 0.00 | 74.74 | BASF | Tannin |
| 30% in H2O | | | | | | | | | | Blocking |
| Luvitec K30, 30% | 23 | 0.00 | 0.00 | 75.01 | 0.00 | 0.00 | 0.00 | 0.00 | BASF | Tannin |
| in H2O | | | | | | | | | | Blocking |
| Water | 24 | 45.02 | 10.22 | 10.21 | 43.25 | 27.33 | 0.00 | 0.00 | | |
| RM 8W | 25 | 7.36 | 7.36 | 7.36 | 6.14 | 6.14 | 7.43 | 7.33 | Rohm & | Thickener |
| | | | | | | | | | Haas | |
| Total | | 1189.47 | 1190.23 | 1190.23 | 1120.16 | 1121.70 | 1190.23 | 1184.04 | | |

*“Pounds” in the table refer to pounds of material per 100 gallons.

### III. Preparation of Coating Examples 1-7

Items 1 and 2 are mixed for 5 minutes in a vessel equipped with a high shear “Cowles” blade. Item 3 is added to affect dissolution of item 2. Items 4-6 are added and mixed 5 minutes. Items 7 and 8 are added, the blade speed is increased and the mixer is run for about 10 minutes to completely disperse the pigment.

For examples 1-3, item 9 is added to a mixer. Items 12-14 and premixed and added to item 9. Items 15-24, as used in these examples, are added in order. The pigment dispersion, items 1-8, is added. Finally, item 25 is added slowly and as needed to reach the desired paint viscosity.

For examples 4-7, item 10 or 11 is added to a mixer. Items 15-24, as used in these examples, are added in order. The pigment dispersion, items 1-8, is added. Finally, item 25 is added slowly and as needed to reach the desired paint viscosity.

### IV. Tannin Migration (Bleed) Resistance Test

Coatings from examples 1-7 were tested as a primer coating for their ability to prevent tannin bleed or migration. These coatings were brush applied to rough cut cedar shakes at a spread rate of 300 square feet per gallon and allowed to air dry. Initial color readings were obtained instrumentally. A white acrylic latex topcoat, Valspar Ultra Premium Interior/Exterior High Gloss Enamel, was applied at a spread rate of 400 square feet per gallon and allowed to air dry. Color readings were obtained instrumentally. Color readings are reported as Yellowness Index (YI) with the yellowness index being calculated per ASTM D 1925. Color between coatings is compared per ASTM D 2244-85.

A water-borne control paint was used in this testing. Kilz 2 from Masterchem is a latex interior/exterior water-based primer with a label description as a Multi-Purpose Stain Blocking Formula and available at hardware and paint stores. Application and color readings were done in the same fashion as used for Examples 1-7.

### V. Comparative Color Values for Primed Cedar Shakes

### Primer YI Values

| | | Tannin | Primer | |
|---|---|---|---|---|
| Primer | Binder | Blocking Additive | YI | Difference |
| Example 1 | Alkyd Emulsion | None | 13.64 | Control |
| Example 2 | Alkyd Emulsion | Vinyl pyrrolidone | 12.29 | −1.35 |
| | | copolymer | | |
| Example 3 | Alkyd Emulsion | Vinyl pyrrolidone | 12.57 | −1.07 |
| | | polymer | | |
| Example 4 | Styrene Acrylic | None | 13.20 | Control |
| | Latex | | | |
| Example 5 | Styrene Acrylic | Vinyl pyrrolidone | 11.89 | −1.31 |
| | Latex | copolymer | | |
| Example 6 | Acrylic Latex | None | 11.24 | Control |
| Example 7 | Acrylic Latex | Vinyl pyrrolidone | 9.16 | −2.08 |
| | | copolymer | | |
| Kilz 2 | Latex | Proprietary | 16.09 | N/A |

Yellowness Index converts color values from a 3 value, 3 dimensional scale to a convenient single number. The yellow-brown staining induced by tannin migration into a primer and/or topcoat results in a higher YI value compared to a non-stained coating. A difference in YI value of 0.75 is visually significant. Comparing the primer YI values clearly demonstrates the advantage of adding either vinyl pyrrolidone polymer or copolymer to alkyd emulsion, styrene acrylic emulsion or acrylic emulsion. The YI is much lower for primers containing these additive polymers. The degree of improvement is as much as 2.08 YI units for Example 6 and 7, and at least 1.30 YI units as seen in Example 1 and 2. Both the vinyl pyrrolidone polymer and copolymer at least partially block the migration of tannin into the primer.

### VI. Comparative YI Values for Primed and Topcoated Cedar Shakes

### Primer Plus Topcoat YI Values

| | | Tannin | Topcoat | |
|---|---|---|---|---|
| Primer | Binder | Blocking Additive | YI | Difference |
| Example 1 | Alkyd Emulsion | None | 10.72 | Control |
| Example 2 | Alkyd Emulsion | Vinyl pyrrolidone | 9.05 | −1.67 |
| | | copolymer | | |
| Example 3 | Alkyd Emulsion | Vinyl pyrrolidone | 8.41 | −2.31 |
| | | polymer | | |
| Example 4 | Styrene Acrylic | None | 7.40 | Control |
| | Latex | | | |
| Example 5 | Styrene Acrylic | Vinyl pyrrolidone | 6.50 | −0.90 |
| | Latex | copolymer | | |
| Example 6 | Acrylic Latex | None | 8.50 | Control |
| Example 7 | Acrylic Latex | Vinyl pyrrolidone | 6.81 | −1.69 |
| | | copolymer | | |
| Kilz 2 | Latex | Proprietary | 9.28 | N/A |

The much lower YI values recorded for topcoats applied over primers containing either vinyl pyrrolidone polymer or copolymer shows that these products may bind tannin in the primer and prevent migration into the topcoat. This is seen for all classes of test polymer, alkyd emulsion, styrene acrylic latex and pure acrylic latex. The difference in YI seen is, at a minimum, 0.9 YI units for Examples 4 and 5, visually significant, and as much as 2.31 YI units for Examples 1 and 3. Further, the presence of vinyl pyrrolidone polymer or copolymer used in alkyd emulsion polymers provides a topcoat color superior to that of the commercial Kilz 2 primer.

### VII. Accelerated Testing of Tannin Migration Resistance

An accelerated test method for tannin migration resistance is described in ASTM D 6686-01. The painted surface of these cedar panels was exposed for 16 hours to 100 degrees F. at 100% relative humidity. These conditions are known to extract tannin from the substrate cedar and through coatings not designed to block tannin migration. This procedure was employed for the panels prepared from Examples 1-7 and the commercial control. Following this exposure, color readings were taken. The YI value for these primers/topcoats is reported in the table below.

### Primer Plus Topcoat Exposed Per ASTM D 6686-01

| | | | Ex- | |
|---|---|---|---|---|
| | | Tannin | posed | |
| Primer | Binder | Blocking Additive | YI | Difference |
| Example 1 | Alkyd Emulsion | None | 13.80 | Control |
| Example 2 | Alkyd Emulsion | Vinyl pyrrolidone | 7.88 | −5.92 |
| | | Copolymer | | |
| Example 3 | Alkyd Emulsion | Vinyl pyrrolidone | 6.17 | −7.63 |
| | | polymer | | |
| Example 4 | Styrene Acrylic | None | 5.89 | Control |
| | Latex | | | |
| Example 5 | Styrene Acrylic | Vinyl pyrrolidone | 5.01 | −0.88 |
| | Latex | copolymer | | |
| Example 6 | Acrylic Latex | None | 9.71 | Control |
| Example 7 | Acrylic Latex | Vinyl pyrrolidone | 9.26 | −0.45 |
| | | copolymer | | |
| Kilz 2 | Latex | Proprietary | 8.1 | N/A |

The much lower YI values recorded for top coats applied over primers containing either vinyl pyrrolidone polymer or copolymer shows that these products may bind tannin firmly in the primer and thus, block tannin migration into the topcoat. This is seen for all classes of test polymer, alkyd emulsion, styrene/acrylic latex and pure acrylic latex. This test indicates that the coating composition comprising vinyl pyrrolidone polymer or copolymer may at least partially block the migration of tannins from substrate into topcoats in long-term use.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. A coating composition comprising:
a) at least one resin binder,
b) at least one vinyl pyrrolidone based polymer or copolymer, or a combination thereof, and
wherein the coating composition at least partially blocks tannin migration.

2. The composition of claim 1, wherein the resin binder is waterborne.

3. The composition of claim 1, wherein the at least one resin binder is selected from the group consisting of acrylic latex, vinyl acetate/acrylic latex, vinyl acetate/ethylene latex, styrene/acrylic latex, styrene/butadiene latex, natural rubber latex, alkyd latex, alkyd/acrylic hybrid resins, water reducible alkyds and a combination thereof.

4. The composition of claim 1, wherein the at least one resin binder is alkyd latex.

5. The composition of claim 1, wherein the at least one resin binder is acrylic latex or styrene/acrylic latex.

6. The composition of claim 1, wherein the molecular weight of the vinyl pyrrolidone based polymer or copolymer is in the range of about 1000 to about 1,000,000 Daltons.

7. The composition of claim 1, wherein at least one vinyl pyrrolidone based copolymer is a copolymer of vinyl pyrrolidone and an ethylenically unsaturated compound.

8. The composition of claim 7, wherein the ethylenically unsaturated compound is selected from the group consisting of ethylene, propylene, acrylates, methacrylates, vinyl acetate, styrene, vinyl toluene, ethylene chloride and a combination thereof.

9. The composition of claim 7, wherein the ethylenically unsaturated compound is vinyl acetate.

10. The composition of claim 1, wherein the weight ratio of the resin binder to vinyl pyrrolidone based polymer or copolymer is in the range of about 25/75 to about 99/1 mass units.

11. The composition of claim 1, wherein the weight ratio of the resin binder to vinyl pyrrolidone based polymer or copolymer is in the range of about 80/20 to about 95/5 mass units.

12. The composition of claim 1, wherein the weight ratio of the resin binder to vinyl pyrrolidone based polymer or copolymer is in the range of about 90/10 mass units.

13. The composition of claim 1 further comprising pigments, extenders, rheology modifiers, cosolvents, coalescents, wetting agents, flow/leveling agents, viscosity controlling agents, pH controlling agents, slip resistant agents, mar resistant agents, UV stabilizers, catalysts, drier metals and/or biocides.

14. A method of at least partially blocking tannin migration comprising the step of:
applying a coating composition to a substrate, wherein the coating composition comprises at least one resin binder and at least one vinyl pyrrolidone based polymer or copolymer or a combination thereof.

15. The method of claim 14, wherein the substrate is a tannin-containing substrate or tannin-stained substrate.

16. The method of claim 14, the coating composition is applied as a primer.

17. A coated substrate comprising:
a) a tannin-containing substrate or tannin-stained substrate,
b) a coating on said substrate comprising at least one resin binder and at least one vinyl pyrrolidone based polymer or copolymer or a combination thereof,
wherein said coating can at least partially block the migration of tannin from the substrate.

18. The coated substrate of claim 17, wherein said substrate is a tannin-containing substrate.

19. The coated substrate of claim 18, wherein said tannin-containing substrate is selected from the group consisting of wood, paper, cardboard, plywood, particle board, chip board and strand board.

20. The coated substrate of claim 19, wherein said wood is selected from the group consisting of redwood, dark wood, cedar, white pine, yellow pine and oak.

21. The coated substrate of claim 19, wherein said wood is selected from the group consisting of redwood, cedar, and oak.
